(19) United States
(12) Patent Application Publication
(10) Pub. No.: US 2010/0003654 A1
(43) Pub. Date: Jan. 7, 2010

(54) PRAYER BOX

(75) Inventor: Gregory E. Thompson, St. Paul, MN (US)

Correspondence Address: NIKOLAI & MERSEREAU, P.A., 900 SECOND AVENUE SOUTH, SUITE 820, MINNEAPOLIS, MN, 55402, US

(73) Assignee: THOMPSON ENGINEERING CO., St. Paul, MN (US)

(21) Appl. No.: 12/167,861

(22) Filed: Jul. 3, 2008

(51) Int. Cl. G09B 19/00

(52) U.S. Cl. 434/245

(57) ABSTRACT

In some embodiments, a computer-usable medium having computer readable instructions stored thereon for execution by a processor to perform a method may include one or more of the following steps: (a) accepting a user's initial preferences regarding prayer, (b) accepting a user's input regarding prayer selection, (c) saving a prayer to memory based upon a user's selection, (d) creating an initial user's profile, (e) accepting a user's preference regarding religion, (f) accepting a user's preference regarding religious denomination, (g) accepting a user's input regarding what times the user plans to pray, (h) accepting a user's input regarding in what manner a user wishes a prayer to be presented, and (i) creating a prayer based upon a user's input.

### BACKGROUND OF THE INVENTION

I. Field of the Invention

Embodiments of the present invention relate to responsive electronic communications. Particularly, embodiments of the present invention relate to electronic devices responsive to human input. More particularly, embodiments of the present invention relate to an electronic prayer device.

II. Discussion of Related Art

Prayer is the act of attempting to communicate, commonly with a sequence of words, with a deity or spirit for the purpose of worshipping, requesting guidance, requesting assistance, confessing sins, as an act of reparation or to express one's thoughts and emotions. The words of the prayer may take the form of intercession, a hymn, incantation or a spontaneous utterance in the person's praying words. Secularly, the term can also be used as an alternative to “hope”.

The great spiritual traditions offer a wide variety of devotional acts. There are morning and evening prayers, graces said over meals, and reverent physical gestures. Some Christians bow their heads and fold their hands. Native Americans dance. Some Sufis whirl. Hindus chant. Orthodox Jews sway their bodies back and forth and Muslims kneel. Quakers keep silent. Some pray according to standardized rituals and liturgies, while others prefer extemporaneous prayers. Still others combine the two. Among these methodologies are a variety of approaches to understanding prayer: the belief the finite can actually communicate with the infinite; the belief the infinite is interested in communicating with the finite; the belief prayer is intended to inculcate certain attitudes in the one who prays, rather than to influence the recipient; the belief prayer is intended to train a person to focus on the recipient through philosophy and intellectual contemplation; the belief prayer is intended to enable a person to gain a direct experience of the recipient; the belief prayer is intended to affect the very fabric of reality as we perceive it; the belief prayer is a catalyst for change in one's self and/or one's circumstances, or likewise those of third party beneficiaries; and the belief the recipient desires and appreciates prayer.

The act of prayer is attested in written sources as early as 5,000 years ago. Some anthropologists believe the earliest intelligent modern humans practiced something we would recognize today as prayer.

Praying has many different forms. Prayer may be done privately and individually, or it may be done corporately in the presence of fellow believers. Prayer can be incorporated into a daily “thought life”, in which one is in consistant communication with a god. Some people pray throughout the day and seek guidance as the day progresses. There can be many different answers to prayer, just as there are many ways to interpret an answer to a question, if there in fact comes an answer. Some may experience audible, physical or mental epiphanies. If indeed an answer comes, the time and place it comes is considered random. Some outward acts sometimes accompanying prayer are: anointing with oil; ringing a bell; burning incense or paper, lighting a candle or candles; facing a specific direction (e.g., towards Mecca or the East); making the sign of the cross. One less noticeable act related to prayer is fasting.

A variety of body postures may be assumed, often with specific meaning (mainly respect or adoration) associated with them: standing; sitting; kneeling; prostrate on the floor; eyes opened; eyes closed; hands folded or clasped; hands upraised; holding hands with others; a laying on of hands and others. Prayers may be recited from memory, read from a book of prayers or composed spontaneously as they are prayed. They may be said, chanted or sung. They may be with musical accompaniment or not. There maybe a time of outward silence while prayers are offered mentally. Often, there are prayers to fit specific occasions, such as the blessing of a meal, the birth or death of a loved one, other significant events in the life of a believer, or days of the year that have special religious significance.

It would be desirable to make prayers more interesting and meaningful. It would be desirable to not have the same prayer repeated over and over again. It would also be desirable to have a variety of prayers which can be used in the correct context for a variety of situations.

### SUMMARY OF THE INVENTION

In some embodiments, a computer-usable medium having computer readable instructions stored thereon for execution by a processor to perform a method may include one or more of the following steps: (a) accepting a user's initial preferences regarding prayer, (b) accepting a user's input regarding prayer selection, (c) saving a prayer to memory based upon a user's selection, (d) creating an initial user's profile, (e) accepting a user's preference regarding religion, (f) accepting a user's preference regarding religious denomination, (g) accepting a user's input regarding what times the user plans to pray, (h) accepting a user's input regarding in what manner a user wishes a prayer to be presented, and (i) creating a prayer based upon a user's input.

In some embodiments, a method of presenting prayers may include one or more of the following steps: (a) processing a religious preference profile, (b) selecting a prayer based upon a user's input, (c) presenting a prayer to a user in video and/or audio form, (d) determining if a religious preference profile has been created, (e) creating a prayer based upon a user's input, (f) presenting a prayer praise to be selected by a user, (g) presenting a bible quote to be selected by a user, and (h) storing a prayer selected by a user. In some embodiments, an apparatus for presenting a prayer may include one or more of the following features: (a) a housing, (b) a computing device within the housing, (c) a cover operably coupled to the housing, (d) a display electronically coupled to the computing device for presenting selections options regarding prayer, (e) a button to allow input from a user, (f) a power button, (g) a speaker, and (i) a light for reading activated during a prayer and/or operated separately.

### DESCRIPTION OF DRAWINGS

FIG. 1 shows a block diagram of the internal architecture of a computing device according to some embodiments of the invention;

FIG. 2 shows an elevated profile view of a prayer box in an embodiment of the present invention;

FIG. 3 shows a flow process diagram of operation of a prayer box in an embodiment of the present invention; and

FIG. 4 shows an elevated profile view of a prayer box in an embodiment of the present invention.

### DESCRIPTION OF PREFERRED EMBODIMENT

The following discussion is presented to enable a person skilled in the art to make and use the present teachings. Various modifications to the illustrated embodiments will be readily apparent to those skilled in the art, and the generic principles herein may be applied to other embodiments and applications without departing from the present teachings. Thus, the present teachings are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of the present teachings. Skilled artisans will recognize the examples provided herein have many useful alternatives and fall within the scope of the present teachings.

Embodiments of the present invention allow a user to make the prayer before meals more interesting and meaningful. Presently, most people who pray before meals recite the same prayer they have recited for years. Embodiments of the present invention could provide a variety of prayers be used in the correct context for all types of meals. The prayer box could be used in the home, but may also be useful at special occasions; holidays and events where a prayer or invocation is required/needed/requested. The prayer box could also be used by prayer leaders for new ideas in preparation for prayer groups, religious study and/or practice.

Embodiments of the present invention improve and enhance the few times each day people talk to their creator. It allows the user to praise and give thanks for the meal in a new way. The prayers can be quick, to the point and not encumber the diners or make people uncomfortable. All phrases can be from open sources, such as religious texts, old hymns and writings.

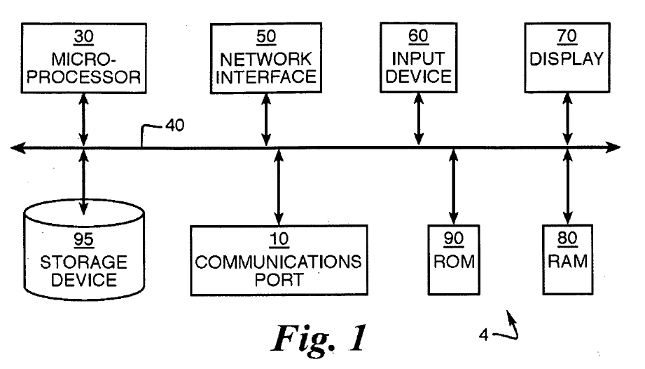

FIG. 1 is a representative block diagram of a computing device according to some embodiments. It is understood computing device 4 could be used to execute program 200 described below. Computing device 4 may comprise a single device or computer, a networked set or group of devices, or computers, such as a workstation, laptop, etc. Computing device 4 is typical of a data session-capable machine. Computing device 4 can include a microprocessor 30 in communication with communication bus 40. Microprocessor 30 is used to execute processor-executable process steps so as to control the components of computing device 4 to provide functionality according to embodiments of the present invention. Microprocessor 30 may comprise a Pentium™ or Itanium™ microprocessor manufactured by Intel™ Corporation. Other suitable processors may be available from Motorola™ Inc., AMD™, or Sun Microsystems™ Inc. Microprocessor 30 also may comprise one or more microprocessors, controllers, memories, caches and the like.

Input device 60 and display 70 are also in communication with communication bus 40. Any known input device may be used as input device 60, including a keyboard, mouse, touch pad, voice-recognition system, or any combination of these devices. Input device 60 may be used by a user to input information and commands.

Display 70 may be an integral or separate CRT display, a flat-panel display or the like. Display 70 is generally used to output graphics and text to an operator in response to commands issued by microprocessor 30.

RAM (Random Access Memory) 80 is connected to communication bus 40 to provide microprocessor 30 with fast data storage and retrieval. In this regard, processor-executable process steps being executed by microprocessor 30 are typically stored temporarily in RAM 80 and executed therefrom by microprocessor 30. ROM (Read-Only Memory) 90, in contrast, may provide storage from which data can be retrieved but to which data cannot be stored. Accordingly, ROM 90 may be used to store invariant process steps and other data, such as basic input/output instructions and data used during system boot-up or to control input device 60. One or both of RAM 80 and ROM 90 may communicate directly with microprocessor 30 instead of over communication bus 40, or on separate dedicated busses.

Data storage device 95 stores, among other data, processor-executable process steps of program 200. The process steps and program code of program 200 and the like may be read from a computer-readable medium, such as a floppy disk, a CD-ROM, a DVD-ROM, a Zip™ disk, a magnetic tape or a signal encoding the process steps/program code and then stored in data storage device 95 in a raw, compressed, un-compiled and/or encrypted format. In alternative embodiments, hard-wired circuitry may be used in place of or in combination with processor-executable process steps for implementation of the processes described herein. Thus, embodiments are not limited to any specific combination of hardware, firmware and software.

Also illustrated is a network interface 50 which may be a wired or wireless Ethernet interface, a modem interface, and so on. In utilizing the various embodiments of the invention, network interface 50 may be connected to or provide access to a high-speed connection to the Internet or an Intranet provider giving access to the Internet or similar networks. Using such a network or networks, computing device 4 can communicate identifiers of destination parties to a mobile application server.

Stored in data storage device 95 may also be other elements necessary for operation of computing device 4, such as other applications, other data files, a network server, an operating system, a database management system and “device drivers” for allowing microprocessor 30 to interface with external devices. These elements are known to those skilled in the art and are therefore not described in detail herein.

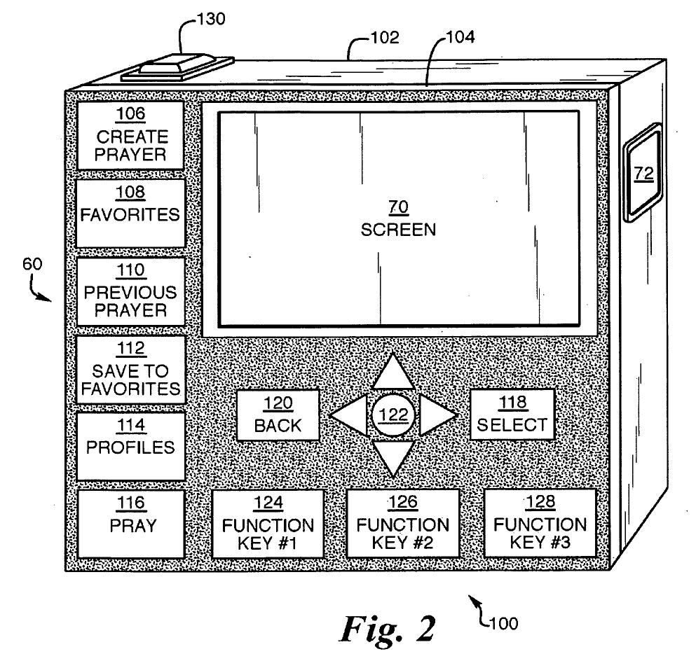

With reference to FIG. 2, an elevated profile view of a prayer box in an embodiment of the present invention is shown. Prayer box 100 can have a housing 102 with a cover 104. Cover 104 can have all of the user input and output functionality, such as display 70 and input device 60. Input device 60 can have a plurality of user function buttons so the user can effectuate the prayer of their choice. Create prayer button 106 allows a user to create their very own prayer utilizing display 70 and listen to the prayer through speaker 72. Favorites button 108 allows a user to pick from prayers stored in a favorites location on storage device 95. Previous prayer button 110 allows a user to play a previously played prayer stored in RAM 80. Save to Favorites button 112 allows a user to store any prayer to a favorites location on storage device 95. Profiles button 114 allows a user to select from a plurality of religious profiles such as Christian, Jewish, Muslim, or even non-denominational. Pray button 116 would initiate prayer box 100 to begin the prayer.

Select button 118 allows a user to select from certain choices shown on display 70 as will be discussed in more detail below. Back button 120 allows a user to return to a previous screen. Directional buttons 122 allow a user to easily navigate through choices shown on display 70. Function keys #1, #2 and #3 respectively 124, 126 and 128 allow a user to create special functions for prayer box 100. For example, if a household contains members of multiple religions, function key 124 could be used to switch to Jewish prayers from Christian prayers. Function key 126 could be used to switch the voice of the prayer reader from male to female to child. Function key 128 could be used to have the prayer appear on display 70 as a scrolling readout for a user to read.

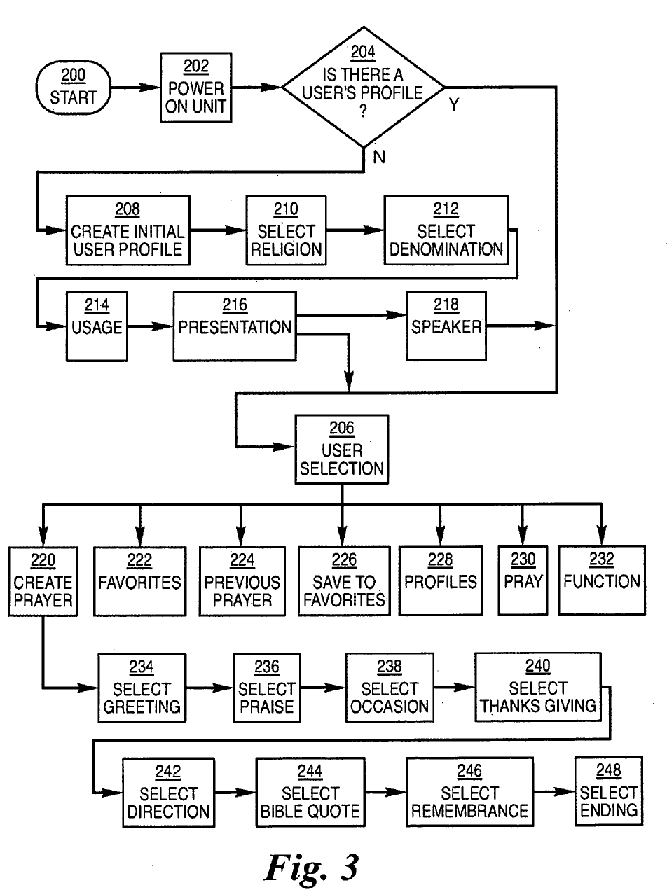

With reference to FIG. 3, a flow process diagram of operation of a prayer box in an embodiment of the present invention is shown. Prayer program 200 can begin by the user powering up prayer box 100 by pressing power button 130 at state 202. Program 200 can start up by determining if a user's profile has been created at state 204. If a profile has been created, program 200 proceeds to state 206 where the user can begin to select from many operations they would like prayer box 100 to perform. If a profile has not been created, the user is prompted to create an initial setup profile at state 208. At state 210 the user can select a religion. Regarding religions, the user can select from the many religions of the world, such Christianity, Islam, Judaism (and sometimes the Bahá'i Faith), Hinduism, Buddhism, Sikliism, Jainism, Chinese folk religion, Confucianism. Taoism and Shinto.

At state 212 the user can then select a denomination of their selected religion. Such denominations include: Catholicism, Eastern Orthodoxy, Protestantism, Oriental Orthodoxy, and Nestorianism for Christianity; Sunnism, Shi'ism, Sufism, and Kharijites for Islam; Shaivism, Vaishnavism, Shaktism, Smartism for Hinduism; Theravada, Mahayana, and Vajrayana for Buddhism; and Hasidic, Orthodox, Conservative, and Reform for Judaism. Next the user can select the times the user expects to use the prayer box at state 214. Here the user can selection meal times, holidays, designated prayer times, and special events such as weddings and funerals. The user can then select a method of presentation of the prayer at state 216. The user can have prayer box 100 present the prayer over speaker 72 and/or present the prayer in written form on display 70. If the user desires prayer box 100 to present the prayers in a spoken form, the user can select from a male, female, or child's voice at state 218. If the user only wants the prayers to be presented in written form, then program 200 proceeds to state 206.

The many differing prayers of all the religions and denominations can be stored on storage device 95. The prayer information can be loaded onto computer 4 through communications port 10 by a master programmer during production. It is further contemplated the prayers could be spoken in a language dependent upon where prayer box 100 was being sold. For example, if prayer box 100 was being sold in Mexico, then all prayers could be programmed into prayer box 100 in Spanish. There are many other options which cold be added to the profile setup without departing from the spirit of the invention. Further, the user can always return and change aspects of the profile by simply pressing profiles button 114. Once a profile is created it can be stored on storage device 95.

Program 200 can now proceed to state 206 where the user can select to create a prayer at state 220, pick a favorite prayer at state 222, pick the previous prayer at state 224, save a favorite prayer at state 226, set or change a profile at state 228, initiate a prayer at state 230, or create a function at state 232.

By pressing create prayer button 106 the user can create a prayer at state 220. The user could be prompted to first select a greeting at state 234. The user could scroll through various greetings using buttons 122 and select a greeting such as “dear heavenly father”. At state 236 the user could select a praise such as “our lord and savior”. An occasion can be selected such as “we are gathered for this meal” at state 238. At state 240 the user could select the thanks giving such as “thank you for these blessings, may they strengthen us”. The user could select a direction such as “go in peace, serve the lord” at state 242.

At state 244 the user could select a religious text quote such as “blessed are the meek, they will inherit the earth”. The user can select a remembrance such as “remember our Grandmother” at state 246. And, at state 248 the user can select an ending such as “in your name, amen”.

The user could pick a prayer from a list of favorites by pressing favorites button 108 at state 222. Here a list of already chosen favorite prayers is displayed on display 70. The user can scroll through the favorites list with scroll buttons 122 and find a favorite prayer. When the user identifies a favorite prayer, they simply scroll to the prayer and press select button 118. The user would then press pray button 116 and begin the prayer at state 230. All previous prayers could be held in storage device 95.

The user could pick a previous prayer from a list of previous prayers by pressing previous prayers button 110 at state 224. Here a list of previous prayers is displayed on display 70. The user can scroll through the previous prayers list and find a prayer they would like to hear or read again. When the user identifies a previous prayer, they would simply scroll to the prayer and press select button 118. The user would then press pray button 116 and begin the prayer at state 230. It is fully contemplated all previous prayer could be stored or only a small set of the previous prayers.

The user can elect to save a prayer to a favorite's list by pressing save to favorites button 112 at state 226. After a prayer has been played or displayed, the user will have the opportunity to save the prayer to a favorite's list stored on storage device 95 discussed above. After the prayer is played or displayed, the user would simply use arrow keys 122 to highlight a “save to favorites” box on display 70 and press select button 118. The prayer would then be stored on storage device 95 on a favorites list and can easily be retrieved by pressing favorites button 108 as discussed above. It is further contemplated, the user would be able to select from the display to erase, print (if prayer box 100 is connected to a network or printer), and play a prayer again at state 226 without departing from the spirit of the invention.

The user can modify, reset or add a profile by pressing on profiles button 114 at state 228. This will take the user to state 208 where the user can begin creating or modifying a profile. Creating a profile is discussed in great detail above. It is fully contemplated prayer box 100 could hold an unlimited number of profiles.

The user can initiate a prayer at any time by pressing pray button 1-16 at state 230. This button begins whatever prayer is,selected for whatever method of presentation is selected.

At state 232, the user can create specialized buttons utilizing function keys 124, 126 and 128 as discussed above.

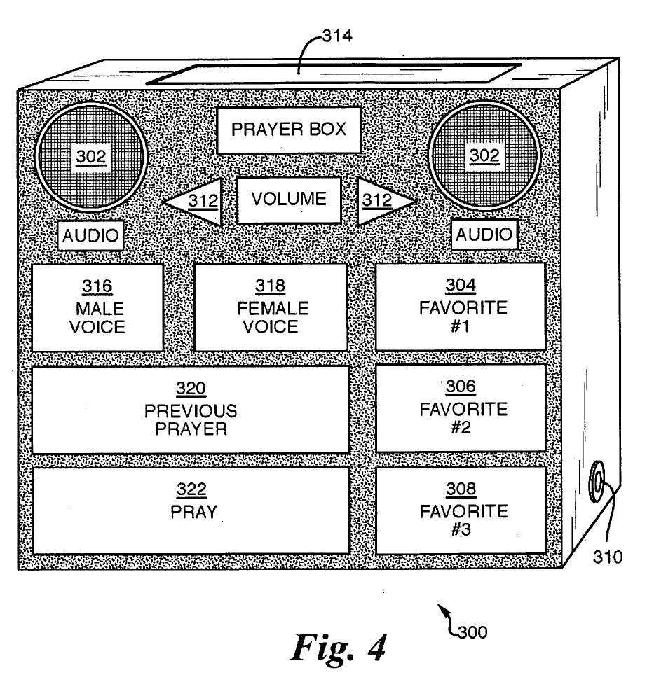

With reference to FIG. 4, an elevated profile view of a prayer box in an embodiment of the present invention is shown. In this embodiment, prayer box 300 has a more simple design. Prayer box 300 has speakers 302 as the prayer is conveyed only by voice. Favorites buttons 304, 306 and 308 respectively allow favorite prayers to easily be saved. There is no need to scroll through a screen of prayers as there is no display. This assists in keeping power usage down also making prayer box 300 able to be solar or battery powered. This embodiment eliminates the need to create profiles and minimizes operator interface. There can be an external port 310 to plug in speakers if there was going to be a big room or many people.

Volume button 312 allows a user to control the sound level of a prayer. Light 314 allows a user to read, perhaps a prayer, while prayer box 300 is operating. Male voice and female voice buttons 316 and 318 allow the user to choose the voice in which in prayer will be read. Previous prayer button 320 allows a user to select a previously played prayer. Pray button 322 allows a user to begin a prayer presentation. Thus, embodiments of the PRAYER BOX are disclosed. One skilled in the art will appreciate the present teachings can be practiced with embodiments other than those disclosed. The disclosed embodiments are presented for purposes of illustration and not limitation, and the present teachings are limited only by the following claims.

We claim:

1. A computer-usable medium having computer readable instructions stored thereon for execution by a processor to perform a method comprising:
accepting a user's initial preferences regarding prayer;
accepting a user's input regarding prayer selection; and
saving a prayer to memory based upon a user's selection.

2. The processor of claim 1, further performing the method of creating an initial user's profile.

3. The processor of claim 1, further performing the method of accepting a user's preference regarding religion.

4. The processor of claim 1, further performing the method of accepting a user's preference regarding religious denomination.

5. The processor of claim 1, further performing the method of accepting a user's input regarding what times the user plans to pray.

6. The processor of claim 1, further performing the method of accepting a user's input regarding in what manner a user wishes a prayer to be presented.

7. The processor of claim 1, further performing the method of creating a prayer based upon a user's input.

8. A method of presenting prayers, comprising the steps of:
processing a religious preference profile;
selecting a prayer based upon a user's input; and
presenting a prayer to a user in video and/or audio form.

9. The method of claim 8, further comprising the step of determining if a religious preference profile has been created.

10. The method of claim 9, further comprising the step of creating a prayer based upon a user's input.

11. The method of claim 10, further comprising the step of presenting a prayer praise to be selected by a user.

12. The method of claim 11, further comprising the step of presenting a bible quote to be selected by a user.

13. The method of claim 12, further comprising the step of storing a prayer selected by a user.

14. An apparatus for presenting a prayer, comprising:
a housing;
a computing device within the housing;
a cover operably coupled to the housing; and
a display electronically coupled to the computing device for presenting selections options regarding prayer.

15. The apparatus of claim 14, further comprising a button to allow input from a user.

16. The apparatus of claim 15, further comprising a power button.

17. The apparatus of claim 16, further comprising a speaker.

18. The apparatus of claim 14, wherein a user can create a user prayer profile to be stored on the computing device.

19. The apparatus of claim 14, wherein a user can create a prayer to be stored on the computing device.

20. The apparatus of claim 14, wherein a user can create a list of favorite prayers to be stored on the computing device.

21. The apparatus of claim 14, wherein a user can create an original and unique prayer by assembling portions of prayers.

22. The apparatus of claim 21, wherein the computing device allows the user to save, erase, print, and/or play the created prayer again.

23. The apparatus of claim 21, wherein the computing device offers the user the choice of voice to the user.

24. The apparatus of claim 14, further comprising a light for reading activated during a prayer and/or operated separately.
